(19) United States
(12) Patent Application Publication
(10) Pub. No.: US 2013/0297525 A1
(43) Pub. Date: Nov. 7, 2013

(54) SYSTEMS, METHODS, AND COMPUTER-READABLE MEDIA FOR LOGICAL CLUSTERING OF PACKAGE DATA AND DERIVED ANALYTICS AND SHARING OF SENSOR INFORMATION

(71) Applicant: FEDEX CORPORATE SERVICES, INC., Collierville, TN (US)

(72) Inventors: Ole-Petter Skaaksrud, Lakeland, TN (US); Xiao Zhou, Germantown, TN (US); John David Putman, Olive Branch, MS (US)

(73) Assignee: FedEx Corporate Services, Inc., Collierville, TN (US)

(21) Appl. No.: 13/886,956

(22) Filed: May 3, 2013

Related U.S. Application Data
(60) Provisional application No. 61/642,727, filed on May 4, 2012.

(51) Int. Cl. G06Q 10/08

(52) U.S. Cl. CPC G06Q 10/0833
USPC 705/333

(57) ABSTRACT

Methods, systems, and computer-readable media are disclosed for verifying integrity of a cluster. The methods, systems, and computer-readable media may receive data identifying a first set of packages at a first location and generating a cluster based on the received data. Thereafter, additional data identifying a second set of packages at a second location may be received and the integrity of the cluster at the one or more additional locations may be verified. The integrity of the cluster may be verified based on a comparison of a verification cluster that is generated based on the received data at the second location with the originally generated cluster.

### CROSS-REFERENCE TO RELATED APPLICATIONS

This application claims the benefit of prior-filed U.S. Provisional Application No. 61/642,727, filed May 4, 2012, which is hereby incorporated by reference.

### TECHNICAL FIELD

This disclosure generally relates to systems, methods, and computer-readable media for clustering of packages.

### BACKGROUND

The ability to closely track and predict movement of packages within a package delivery or logistics network is an important element of customer service that is often expected by customers utilizing such services.

Current tracking systems allow for tracking and scanning of individual packages. However, tracking of individual packages does not allow for an accurate prediction of systematic shipment delays because any delays or misplacement may be limited to the individual package. A delay within a logistic system may be based on certain shipments being diverted utilizing unplanned routes due to equipment failure, weather, excess volumes, etc. Additionally, packages within a logistic system may not be properly tracked due to issues associated with scanning, including scanning equipment failure, and unscannable positions of packages, such as the scanning tag being hidden from the scanner on a conveyer belt.

Virtual clusters of packages may be established and tracked at various locations to more accurately indicate shipment failures or other issues in the logistics system.

### SUMMARY

In accordance with one example embodiment, a method for verifying integrity of a cluster is disclosed. The method comprises receiving data identifying a first set of packages at a first location and generating a cluster based on the received data. The method further includes receiving additional data identifying a second set of packages at a second location and verifying integrity of the cluster based, at least in part, on the additional received data.

In accordance with another example embodiment, a system for determining the integrity of a cluster is disclosed. The system comprises a processor for executing program instructions for management of the device, and a non-transitory computer-readable storage medium for storing the program instructions, the processor when executing the program instructions data identifying a first set of packages at a first location and generates a cluster based on the received data. The processor further receives additional data identifying a second set of packages at a second location and verifies integrity of the cluster based, at least in part, on the additional received data.

In accordance with another example embodiment, a non-transitory computer-readable storage medium storing program instructions, which, when executed by a processor, cause the processor to perform a method of management of a communication device aboard an aircraft. The method includes the steps of receiving data identifying a first set of packages at a first location and generating a cluster based on the received data. The method further includes receiving additional data identifying a second set of packages at a second location and verifying integrity of the cluster based, at least in part, on the additional received data.

### BRIEF DESCRIPTION OF THE DRAWINGS

FIG. 1 illustrates an example cluster verification system that may be used for implementing the disclosed embodiments.

FIG. 2 illustrates an example flow chart of an example method of operation for verifying integrity of a cluster in accordance with the disclosed embodiments.

FIG. 3 illustrates an exemplary computer system that may be used for implementing the disclosed embodiments.

### DETAILED DESCRIPTION

Reference will not be made to the exemplary embodiments, examples of which are illustrated in the accompanying drawings. Wherever possible, the same reference numbers will be used throughout the drawings to refer to the same or like parts.

In some embodiments according to this disclosure, a cluster verification system receives location information about packages at various locations. A cluster may be established at a first location and then the cluster's integrity may be verified at a second location. A cluster is a group of packages that are grouped together based on certain characteristics such as being located together at a physical location. Verification of a cluster at second location after the cluster was established at a first location may aid in developing historical data regarding clusters of packages as they are routed through a logistics system. Therefore, if a cluster deviates from normal patterns of maintaining integrity, the logistics system may be determined to have issues that need to be addressed, such as delays or scanning equipment failure.

The identity of a particular package may be physically captured by scanning a machine-readable code such as a 1D or 2D barcode, or RFID tag at a location or by devices with unique identifiers reporting identity plus additional information such as location through GPS signals (e.g., a SenseAware device may be put into packages to track their geographical location). These sensors may further provide data regarding environment statuses of packages such as temperature, humidity, acceleration, etc.

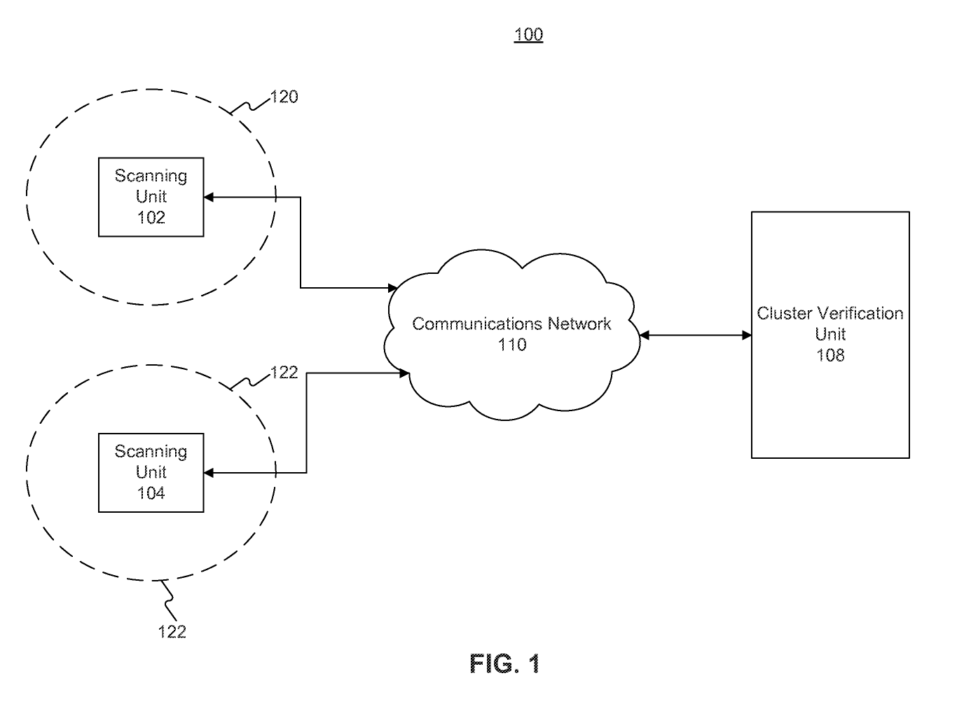

FIG. 1 illustrates an exemplary computing environment 100 that may be used for implementing the disclosed embodiments. Specifically, computing environment 100 may allow for generation of a cluster at a first location and then determination of the integrity of the cluster at secondary scanning locations. As referred to in the disclosure, the first location refers to a location in a logistics route that is physically located before second location in a logistics route. However, the first location is not necessarily the origin of a logistic route. Additionally, there may be multiple scanning locations between the first location and the second location. Computing environment 100 may also develop historical data of cluster integrity. In FIG. 1, scanning unit 102, scanning unit 104, and cluster verification unit 108 are interconnected via a communications network 110. Communications network 110 may represent any form or medium of digital data communication. Examples of communication network 110 include a local area network (LAN), a wireless LAN, e.g., a “WiFi” network, a wireless Metropolitan Area Network (MAN) that connects multiple wireless LANs, a wide area network (WAN), e.g., the Internet, and a dial-up connection (e.g., using a V.90 protocol or a V.92 protocol). Further, the Internet may include any publicly accessible network or networks interconnected via one or more communication protocols, including, but not limited to, hypertext transfer protocol (HTTP) and transmission control protocol/internet protocol (TCP/IP). Moreover, communications network 110 may also include one or more mobile device networks, such as a GSM network or a PCS network, that allow devices, such as scanning unit 102, to send and receive data via applicable communication protocols, including those described above.

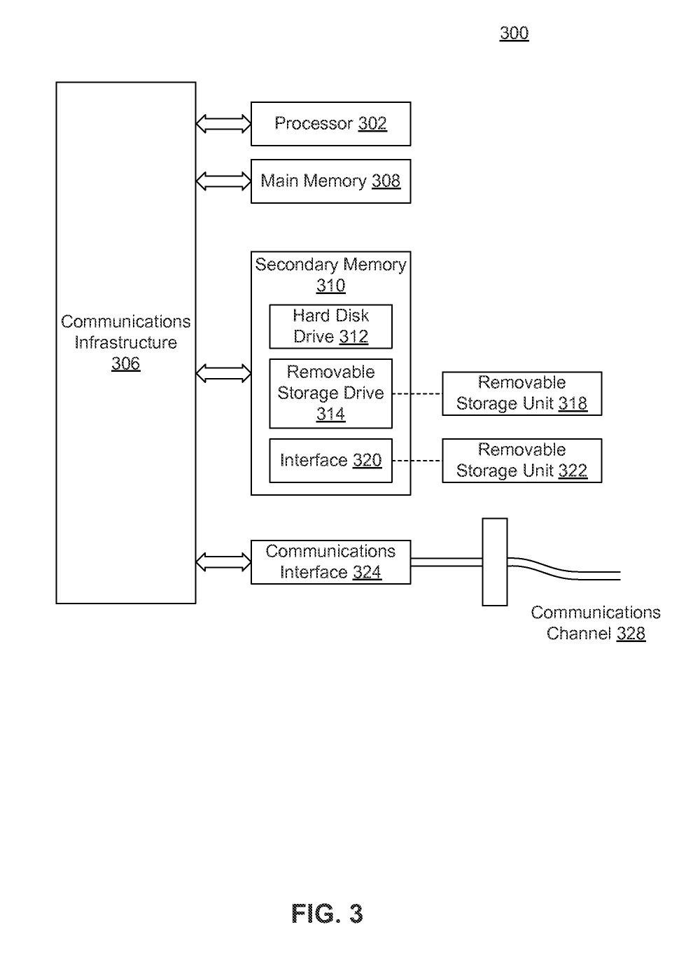

Scanning unit 102, scanning unit 104, and cluster verification unit 108 may be implemented by any type of computing system capable of data processing. An example of a computing system is described herein with reference to FIG. 1. Additional examples of computing systems are described below with reference to FIG. 3.

Scanning unit 102 is present at a first location 120 and the scanning unit 104 is located at a second location 122. One of ordinary skill in the art would comprehend that FIG. 1 does not illustrate the physical distance between the first location 120 and the second location 122, but is rather meant to illustrate that the scanning of packages occurs at two separate physical locations. Furthermore, the computing environment 100 may contain additional scanning units at additional locations which are similar to scanning units 102 and 104. Moreover, while scanning unit 102 and scanning unit 104 are depicted as two separate scanning units, scanning unit 102 and scanning unit 104 may represent the same scanning unit moved from one physical location to another physical location.

In some embodiments, both the scanning units 102 and 104 may include, among other things, one or more scanners (not illustrated) which are able to scan packages or sensors on packages.

Both the scanning units 102 and 104, and cluster verification unit 108 may include any type of processor known in the art (such as, for example, CPUs, ASICs, FPGAs, etc.). Processors perform steps or methods consistent with disclosed embodiments by, for example, reading software instructions from a memory and executing the instructions.

In an example scenario, packages are scanned (scanned hereinafter refers to capturing the identity of the package) by scanning unit 102 at location 120. A cluster may be created utilizing information about these scanned packages by the cluster verification unit 108. For example, a courier vehicle may pick up the packages at location 120 and take them to location 122, where packages are to be sorted for further routing. A cluster of packages that are picked up by the courier at location 120 vehicle is created. Alternatively, instead of scanned data from scanning unit 102, cluster verification unit 108 may simply receive data related to location information of packages directly from sensors placed on the packages at location 120.

To determine integrity of the cluster that was established at location 120, a verification cluster may be generated based on scanning data from scanning unit 104 at location 122. The verification cluster may then be compared with the original cluster that was generated based on data from scanning unit 102 to determine if the original cluster's integrity has been preserved. Alternatively, instead of scanned data from scanning unit 104, cluster verification unit 108 may simply receive data regarding location information of packages directly from sensors placed on the packages at location 122.

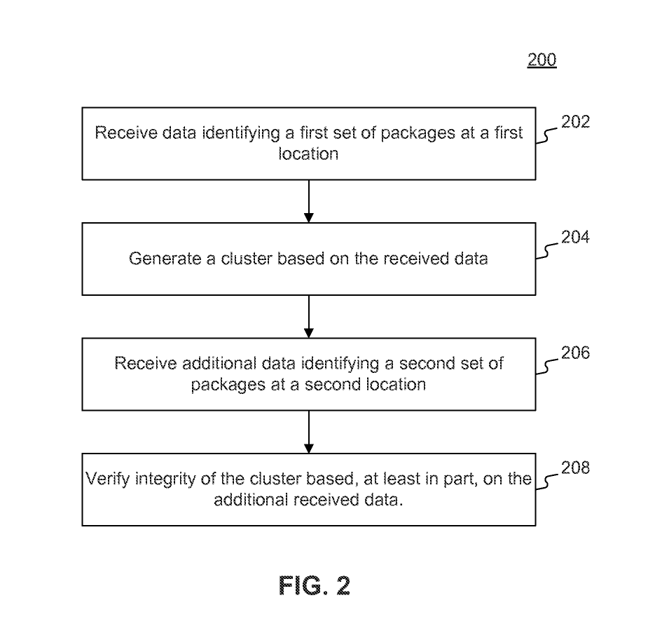

FIG. 2 is a flow chart illustrating an example method of operation 200 for verifying integrity of a cluster. Specifically, for example, method 200 may be used to verify integrity of a cluster which was generated based on data related to location information of packages at location 120 when the cluster's associated packages are present at location 122. The method of operation 200 may be embodied in a set of program instructions or software stored in a memory of cluster verification unit 108 that may be executed by a processor to control cluster verification unit 108.

Method 200 begins with step 202, wherein cluster verification unit 108 receives data identifying a first set of packages at a first location. For example, cluster verification unit 108 may receive data directly from sensors placed on packages at location 120 regarding the presence of packages at location 120 and the time at which the packages arrive or are present at location 120.

Alternatively, data related to scanning of packages at a first location may be sent to cluster verification unit 108. For example, scanning unit 102 located at first location 120 may provide data related to each package that is scanned by the scanning unit 102. This may include time data associated with the time at which each package was scanned.

Regarding, further explanation of this exemplary method, whenever a package is discussed as being scanned, the location information related to a package may also be received directly from a sensor on a package to the cluster verification unit 108, instead of by receiving scan data from respective scan units 102 and 104. The principles of generating clusters and verification clusters (discussed in steps 204 and 208) are the same whether location information about a package is received directly from a sensor on a package or scan data.

In step 204, a cluster may be generated based on the received data. A cluster as described above refers to a group of packages about which a general analysis may be made.

Utilizing the received data, two different types of clusters may be generated, a real-time cluster and a historical data cluster. Any type of cluster that is generated in real-time hereinafter refers to a cluster generated based on data related to packages or objects that is acquired over a period of time, such as seconds or minutes. Generating a real-time cluster entails forming a new cluster upon receipt of data that a first package is located at a first location and thereafter including any additional packages that are determined to be located at the same location within a threshold period of time after the first package is determined to be located at the first location are included in cluster. The threshold period of time may, for example, be from one minute to eight hours. However, depending on the frequency of packages scanned at a particular location and times related to pick-up or shipment from a location, this threshold period of time may be altered.

For an example of real-time clustering, when a first package is scanned at location 120 by scanning unit 102 at 1:00 p.m. and the threshold period of time is 5 minutes, then a first cluster would be generated at the scanning of the first package and any additional packages that are scanned until 1:05 p.m. would be included within the first cluster. To continue this example, the first package arriving after 1:05 p.m., for example, 1:06 p.m., will lead to the generation of a second cluster, where if the threshold period of time remains five minutes, then any additional packages scanned from 1:06 p.m. until 1:11 p.m. will be included within the second cluster.

On the other hand, a historical data cluster may be generated after data is received indicating that a package is located at a particular location and its corresponding tagged time. The tagged time refers to the time that a package is determined to arrive or be first scanned at a location. A historical data cluster is generated retroactively utilizing tagged times of packages. Furthermore, the number of packages that are included in a historical data cluster may be pre-determined. For example, cluster verification unit 108 may utilize historical data of scanned packages along with corresponding scan times to create clusters, that is, a historical data cluster is created retroactively where all the packages included within the cluster have already been scanned. For example, 2000 packages may be scanned from 5:00 p.m. until 5:30 p.m. at location 120. The size limit of packages in a cluster is set as being 500 because analysis for the historical data has shown benefits of this cluster size. The benefit may be in recognizing behavior at that location, or across locations. Therefore, the 2000 packages will be separated into 4 different clusters. The first 500 scanned packages will belong to a first cluster, the second 500 packages to a second cluster, and so on.

In some embodiments, the size of a number of packages in a cluster for a historical data cluster may be determined either based on a manual selection, binary searching, or an optimal number based on other factors. For an example of manual selection, a user may select the number of packages to include in a cluster. For binary searching, certain features of the packages may be selected/searched for so that those packages are included in a cluster. For example, packages may be scanned to be routed to various locations. Scanned features, such as codes, may indicate that certain packages are to be routed together utilizing a vehicle with a certain capacity or based on a vehicle's ability to handling special materials indicated in the code such as handling type for hazardous materials. Therefore, these packages may be clustered together utilizing binary searching which would allow for these codes to be searched. Optimal selection may be a combination of manual selection and binary searching or may take into account additional information such as previous cluster sizes.

The size of a number of packages in a cluster may optimally range from 100 to 1000 packages at a scanning location. However, the clusters may be bigger at a location handling a large amount of packages or smaller at a location handling a small amount of packages. A cluster may include at least two or more objects.

In step 206, cluster verification unit 108 receives additional data identifying a second set of packages at a second location. For example, cluster verification unit 108 may receive data directly from sensors placed on packages at location 122 regarding the presence of packages at location 122 and the time at which the packages were located at location 122.

Alternatively, data related to scanning of packages at a second location may be sent to cluster verification unit 108. For example, scanning unit 104 located at first location 124 may provide data related to each package that is scanned by the scanning unit 104. This may include time data associated with the time at which each package was scanned.

In step 208, cluster verification unit 108 verifies integrity of the cluster based, at least in part, on the additional received data.

Utilizing the received data, integrity of the cluster may be verified utilizing either a real-time cluster verification or a secondary cluster verification. Verifying integrity of the cluster entails generating a verification cluster based on data from the second and comparing it with a cluster based on data from a previous location.

A real-time cluster verification may entail forming a new verification cluster when a first package from the previously generated cluster is scanned. That is, the cluster verification unit 108 retains information regarding a previously generated cluster and when any packages from a previously generated cluster is scanned at the second location, it is determined that package is a first package from the previously generated package. Accordingly, when any additional packages that are scanned within a threshold period of time after the first package is scanned as belonging to the new verification cluster. The threshold period of time may, for example, be from one minute to eight hours. However, depending on the frequency of packages scanned at a particular location and times related to pick-up or shipment from a location, this threshold period of time may be altered. In some embodiments, this threshold period of time may be less than the threshold period of time for generation of a real-time cluster based on scans at location 120 since location 122 may be a sorting facility where all the packages are likely to arrive at the same time.

The verification cluster may be compared with the generated cluster to determine the differences. For example, if a threshold amount of packages are still included in the verification cluster based on scan data from scanning unit 104 that were part of the generated cluster based on scan data from scanning unit 102, it may be determined that the cluster retains its integrity. In an example, if the cluster generated based on scan data at a previous location included 100 packages and the newly generated verification cluster included at least 70% of the packages, it may be determined that the cluster retains its integrity.

In some embodiments, a time corresponding to the first package is set as the initial time tag of a cluster and any additional packages received within a threshold period of time from the time tag of the cluster are included in the verification cluster. In this embodiment, the time tag of the verification cluster is updated based on receipt of packages that previously belonged to the cluster based on scan data at location 120. Therefore, a current time tag of a verification cluster may be the mean or the median times of the package scans belonging to a previously generated cluster based on scan data at location 120. Therefore, as long as packages belonging to the previously generated cluster are being scanned, while the threshold period of time remains the same, the actual time for packages to be part of the verification cluster continues to increase on an ongoing basis. For example, the first package from a previously generated cluster may be scanned at 1 p.m. and the threshold period of time may be 5 minutes. Initially, the time tag of the verification cluster will be 1:00 pm and it will include all scanned packages until 1:05 p.m. However, if a second package from a previously generated cluster is scanned at 1:02 p.m., then the mean of the 1 p.m. and 1:02 p.m., which is 1:01 p.m., would be the tag time of the cluster. Accordingly, all packages that are scanned until 1:06 p.m. will be included in the verification cluster.

Similarly to the real-time generated cluster, because the real-time verifications cluster is based on the basis of time, a size of a number of packages in the cluster cannot be pre-determined.

On the other hand, a secondary verification cluster is similar to the historical data cluster that is generated based on a size limit of packages by taking into account the times that the packages were scanned. Specifically, cluster verification unit 108 utilizes historical data of scanned packages at location 122 along with corresponding scan times to re-create clusters. For example, 2000 packages are scanned from 5:00 p.m. until 5:30 p.m. at location 122. The size limit of a number of packages in a cluster is set as being 500. Therefore, the 2000 packages will be separated into 4 different clusters. The first 500 packages will belong to a first cluster, the second packages to a second cluster, and so on.

In some embodiments, the size of a number of packages in a cluster for a secondary verification cluster may be equal to the size of the generated cluster whose integrity is being verified. Alternatively, it may be determined either based on a manual selection, binary searching, or an optimal number based on other factors similar to the size of the historical cluster described above.

The verification clusters generated based on scanning data from location 122 by scanning unit 104 are then compared to clusters generated based on scanning data from location 120 by scanning unit 102. If the verification clusters contain a threshold amount of packages that the clusters generated based on data from location 120 included, then it may be determined that a respective cluster maintained its integrity.

In some embodiments for determining integrity of the secondary verification cluster, an n number of packages are picked from the original cluster as main packages. If any of the secondary verification clusters contains higher than a threshold number of packages from the n number of packages, than the integrity of the generated cluster is preserved.

Generating and verifying clusters allow for efficiency in the sharing of information. For example, if information is known about one package in a cluster or if data is acquired at the sensor of one package, that information may be shared across other packages in the cluster. In some embodiments, a cluster size may be adjusted based on the characteristics of the data that is to be shared within objects of the cluster. For example, if the data that is being shared is associated with an external package sensor measuring light levels, then because the light level is known to vary greatly at the place of data capture, only the packages immediately around the sensor at the time of sensor data capture would have been exposed to that condition, thus the cluster size would have to be limited accordingly. The same package can, for the sharing of other captured data, such as temperature, be a part of a larger cluster.

The utilization, tracking, and integrity verification may allow for detection of abnormal behavior within a logistics system or determining that the logistics system is operating normally. By tracking clustering behavior over time, it becomes possible to detect when potential failures occur within the logistics system.

The method of operation 200 may be utilized to generate historical patterns for a particular expected route. Accordingly, by utilizing a set of data from a first location to additional locations within a route of a logistics system, a historical pattern may be established regarding expected cluster behavior, that is, a pattern may emerge regarding how many packages leave a cluster, how many packages are added to the cluster, changes in the size of packages of a cluster. These historical patterns may be utilized to generate a historical cluster pattern template that may be used to analyze cluster behavior. In embodiments, historical patterns may be iteratively updated based on additional data received from various locations. Additionally, the historical patterns may be updated based on user intervention.

Therefore, if a cluster deviates from historically established behavior, the cluster of packages may be experiencing an abnormal condition. For example, if a particular route historically has significant verification of cluster integrity, then any significant deviation would indicate the presence of an abnormal condition. Since this applies to a cluster of packages, the abnormal condition likely would be a result of a systematic or system-wide change in how packages are processed. The change may both be controlled and uncontrolled. By using a virtual cluster of packages to track the health of the system, it becomes easier to detect abnormal conditions earlier than if individual packages are tracked. It also allows for the establishment of more robust historical templates of package behavior.

Verifying integrity of a cluster may also indicate that a package is not associated with a cluster where historically most packages join virtual clusters. By not joining a cluster, the package likely is a mis-sorted package. For example, the package may not be part of a cluster at a first location but is included in the verification cluster as a second location.

Alternatively, abnormal behavior with respect to a cluster may be determined if a package has been clustered and leaves the cluster. By comparing the historical rate of package-to-cluster defection, it becomes possible to estimate the likelihood the package leaving the cluster is experiencing an abnormal condition. If the package never rejoins a cluster, it may also fall under the category described in the previous paragraph.

Accordingly, an integrity verification of a cluster may be compared to historical patterns to indicate systematic issues. For example, if in a particular location, there are minimal chances based on historical data that a cluster does not retain its integrity, then a detection of a loss of integrity may trigger a notification or an alarm that certain errors exist in a logistics system.

In embodiments, updated data from a particular location may be utilized to reclassify a cluster. For example, if a size of number of packages in a cluster increases to a threshold level, the cluster may be divided into two or more clusters. Similarly, if a size of number of packages in a cluster decreases to a threshold level, the cluster may be combined with another cluster.

In some embodiments, sensor data that is received from a sensor on a package in the first set of packages may be utilized to determine conditions that are applicable to additional packages in physical vicinity of the package in the first set of packages. For example, if a particular temperature of travel speed is determined for one package, it is likely that the packages surrounding that one package face the same condition.

In some embodiments, the method of operation 200 may be applied numerous times on a logistics route at various locations. Therefore any data from previous location, in addition to the first and second location of the cluster verification may be applied utilizing a weighted method. For example, an initial cluster may be generated at Location A, and then it may be verified at Location B, thereafter a verification may occur at a Location C. The verification at Location C may utilize data from Location A and B in a weighted manner. Additionally, the verification at Location C may utilize the previous verification at Location B. Similarly, historical patterns may be established for verifications over multiple locations on a logistics route.

FIG. 3 illustrates an exemplary computer system 300 that may be used for implementing the disclosed embodiments. The exemplary computer system 300 of FIG. 3 may be used to implement the components of FIG. 1, including, for example, scanning unit 102, scanning unit 104, and cluster verification unit 108.

As shown in FIG. 3, computer system 300 includes one or more processors, such as processor 302. Processor 302 is connected to a communications infrastructure 306, such as a bus or network (e.g., communications network 110 of FIG. 1).

Computer system 300 also includes a main memory 308, for example, a random access memory (RAM), and may include a secondary memory 310. Secondary memory 310 may include, for example, a hard disk drive 312 and/or a removable storage drive 314, representing a magnetic tape drive, an optical disk drive, CD/DVD drive, etc. Removable storage drive 314 reads from and/or writes to a removable storage unit 318 in a well-known manner. Removable storage unit 318 represents a magnetic tape, optical disk, or other non-transitory computer-readable storage medium that is read by and written to by removable storage drive 314. As will be appreciated, the removable storage unit 318 can represent a non-transitory computer-readable medium having stored therein computer programs, sets of instructions, code, or data to be executed by processor 302.

In alternate embodiments, secondary memory 310 may include other means for allowing computer programs or sets of instructions to be loaded into computer system 300. Such means may include, for example, a removable storage unit 322 and an interface 320. An example of such means may include a removable memory chip (e.g., EPROM, RAM, ROM, DRAM, EEPROM, flash memory devices, or other volatile or nonvolatile memory devices) and an associated socket, or other removable storage units 322 and interfaces 320, which allow instructions and data to be transferred from removable storage unit 322 to computer system 300.

Computer system 300 may also include one or more communications interfaces, such as communications interface 324. Communications interface 324 allows computer software, instructions, and/or data to be transferred between computer system 300 and external devices. Examples of communications interface 324 may include a modem, a network interface (e.g., an Ethernet card), a communications port, a PCMCIA slot and card, a wireless transmitter or card, etc. Computer software, instructions, and/or data may be transferred via communications interface 324 in the form of signals (not shown), which may be electronic, electromagnetic, optical, or other signals capable of being received by communications interface 324. These signals are provided to communications interface 324 via a communications path (i.e., channel 328). Channel 328 carries signals and may be implemented using wire or cable, fiber optics, an RF link, wireless transmissions, and other communications channels. In another embodiment, signals comprise data packets sent to processor 302. Information representing processed packets can also be sent in the form of signals from processor 302 through channel 328.

The terms “storage device” and “storage medium” may refer to particular devices including, but not limited to, main memory 308, secondary memory 310, a hard disk installed in hard disk drive 312, and removable storage units 318 and 322. Further, the term “non-transitory computer-readable medium” may refer to devices including, but not limited to, a hard disk installed in hard disk drive 312, any combination of main memory 308 and secondary memory 310, and removable storage units 318 and 322, which respectively provide computer programs and/or sets of instructions to processor 302 of computer system 300. Such computer programs and sets of instructions can be stored within one or more non-transitory computer-readable media. Additionally, or alternatively, computer programs and sets of instructions may also be received via communications interface 324 and stored on the one or more computer-readable media.

Such computer programs and instructions, when executed by processor 302, enable processor 302 to perform one or more of the computer-implemented methods described herein. Examples of program instructions include, for example, machine code, such as code produced by a compiler, and files containing a high-level code that can be executed by processor 302 using an interpreter.

The computer-implemented methods described herein can also be implemented on a single processor of a computer system, such as processor 302 of system 300. In another embodiment, computer-implemented methods consistent with embodiments of the present disclosure may be implemented using one or more processors within a single computer system, and additionally or alternatively, these computer-implemented methods may be implemented on one or more processors within separate computer systems linked via a network.

Various embodiments have been described herein with reference to the accompanying drawings. It will, however, be evident that various modifications and changes may be made thereto, and additional embodiments may be implemented, without departing from the scope of the present disclosure or the subject matter as set forth in the claims that follow.

Further, other embodiments will be apparent to those skilled in the art from consideration of the specification and practice of one or more embodiments disclosed herein. It is intended, therefore, that this disclosure and the embodiments herein be considered as exemplary only, with a true scope and spirit of the present disclosure being indicated by the following listing of exemplary claims.

1. A computer-implemented method comprising:
receiving data identifying a first set of packages at a first location;
generating a cluster based on the received data;
receiving additional data identifying a second set of packages at a second location; and
verifying integrity of the cluster based, at least in part, on the additional received data.

2. The computer-implemented method of claim 1, wherein generating the cluster comprises:
determining a time that a first package is located at the first location; and
including any additional packages that are determined to be located at the first location within a threshold period of time after the first package as belonging to the cluster.

3. The computer-implemented method of claim 1, wherein generating the cluster comprises generating the cluster based on a size limit of number of packages and times that the packages were located at the first location.

4. The computer-implemented method of claim 1, wherein verifying integrity of the cluster at the second location comprises:
generating a verification cluster based on the additional received data; and
comparing the verification cluster with the cluster.

5. The computer-implemented method of claim 4, wherein the verification cluster is generated based on a size limit of number packages and times that the packages were located at the second location.

6. The computer-implemented method of claim 4, the verification cluster is generated based on:
determining a time that a first package from the cluster is located at the second location;
setting the time that the first package is located at the second location as a verification cluster tag time; and
including any additional packages that are determined to be located at the second location within a threshold period of time after the cluster tag time as belonging to the cluster.

7. The computer-implemented method of claim 6, further comprising:
updating the verification cluster tag time as the mean or median of the time that the first package is located at the second location and times associated with any additional packages from the cluster that are located at the second location.

8. The computer-implemented method of claim 2, wherein verifying integrity of the cluster at the second location comprises:
generating a verification cluster based on the received additional data; and
comparing the verification cluster with the cluster.

9. The computer-implemented method of claim 8, wherein the verification cluster is generated based on a size limit of number of packages and times that the packages are located at the second location.

10. The computer-implemented method of claim 8, the verification cluster is generated based on:
determining a time that a first package from the cluster is located at a second location;
setting the time that the first package is located at a second location as a verification cluster tag time; and
including any additional packages that are determined to be located at the second location within a threshold period of time after the cluster tag time as belonging to the cluster.

11. The computer-implemented method of claim 10, further comprising:
updating the verification cluster tag time as the mean or median of the scan time of the first package and times of any additional packages from the cluster that are scanned.

12. The computer-implemented method of claim 3, wherein verifying integrity of the cluster at the second location comprises:
generating a verification cluster based on the received additional data; and
comparing the verification cluster with the cluster.

13. The computer-implemented method of claim 12, wherein the verification cluster is generated based on a size limit of number of packages and times that the packages were located at the second location.

14. The computer-implemented method of claim 12, the verification cluster is generated based on:
determining a time that a first package from the cluster is scanned;
setting the time that the first package is scanned as a verification cluster tag time; and
including any additional packages determined to be at the second location within a threshold period of time after the cluster tag time as belonging to the cluster.

15. The computer-implemented method of claim 14, further comprising:
updating the verification cluster tag time as the mean or median of the time that the first package was located at the second location and location times at the second location of any additional packages from the cluster.

16. A system, comprising:
a processor for executing program instructions for management of the wireless device;
a non-transitory computer-readable storage medium for storing the program instructions, the processor when executing the program instructions:
receives data identifying a first set of packages at a first location;
generates a cluster based on the received data;
receives additional data identifying a second set of packages at a second location; and
verifies integrity of the cluster based, at least in part, on the additional received data.

17. A non-transitory computer-readable storage medium storing program instructions, which, when executed by a processor, cause the processor to perform a verification of a cluster, the method comprising the steps of:
receiving data identifying a first set of packages at a first location;
generating a cluster based on the received data;
receiving additional data identifying a second set of packages at a second location; and
verifying integrity of the cluster based, at least in part, on the additional received data.

18. A computer-implemented method comprising:
receiving data identifying a first set of packages at a first location;
generating a cluster based on the received data;
receiving additional data identifying a second set of packages at a second location, the second set of packages including at least one package from the first set of packages;
generating a verification cluster based, at least in part, on the additional received data;
determining differences between the cluster and the verification cluster;
comparing the determined differences with pre-stored historical patterns of cluster differences.

19. The computer-implemented method of claim 18, further comprising:
determining abnormal cluster behavior responsive to the comparison indicating deviation of more than a threshold level from historical patterns.

20. The computer-implemented method of claim 19, further comprising:
generating an indication of the abnormal cluster behavior.

21. The computer-implemented method of claim 19, wherein determining abnormal behavior comprises one of:
determining an increase in size of a number of packages in the cluster;
determining a decrease in the size of the number of packages in the cluster;
determining an addition of an unexpected package in the cluster;
determining a package in the cluster to unexpectedly depart from the cluster.

22. The computer-implemented method of claim 20, further comprising:
determining normal cluster behavior responsive to the comparison indicating deviation of less than a threshold level from historical patterns.

23. The computer-implemented method of claim 18, wherein the second location is included on an expected route for at least one package from the first set of packages.

24. The computer-implemented method of claim 18, wherein generating the cluster comprises:
determining a time that a first package is located at the first location; and
including any additional packages that are determined to be located at the first location within a threshold period of time after the first package as belonging to the cluster.

25. The computer-implemented method of claim 18, wherein generating the cluster comprises generating the cluster based on a size limit of number of packages and times that the packages were located at the first location.

26. The computer-implemented method of claim 18, wherein the verification cluster is generated based on a size limit of number packages and times that the packages were located at the second location.

27. The computer-implemented method of claim 18, wherein generating verification cluster comprises:
determining a time that a first package from the cluster is located at the second location;
setting the time that the first package is located at the second location as a verification cluster tag time; and
including any additional packages that are determined to be located at the second location within a threshold period of time after the cluster tag time as belonging to the cluster.

28. A system, comprising:
a processor for executing program instructions for management of the wireless device;
a non-transitory computer-readable storage medium for storing the program instructions, the processor when executing the program instructions:
receives data identifying a first set of packages at a first location;
generates a cluster based on the received data;
receives additional data identifying a second set of packages at a second location, the first second set of packages including at least one package from the first set of packages;
generates a verification cluster based, at least in part, on the additional received data;
determines differences between the cluster and the verification cluster;
compares the determined differences with pre-stored historical patterns of cluster differences.

29. A non-transitory computer-readable storage medium storing program instructions, which, when executed by a processor, cause the processor to perform a verification of a cluster, the method comprising the steps of:
receiving data identifying a first set of packages at a first location;
generating a cluster based on the received data;
receiving additional data identifying a second set of packages at a second location, the first second set of packages including at least one package from the first set of packages;
generating a verification cluster based, at least in part, on the additional received data;
determining differences between the cluster and the verification cluster;
comparing the determined differences with pre-stored historical patterns of cluster differences.
